(19) United States
(12) Patent Application Publication
(10) Pub. No.: US 2026/0022219 A1
(43) Pub. Date: Jan. 22, 2026

(54) METHOD FOR PRODUCING STRETCHED FILM

(71) Applicant: KANEKA CORPORATION, Osaka-shi (JP)

(72) Inventor: Yuma MAEDA, Settsu-shi (JP)

(73) Assignee: KANEKA CORPORATION, Osaka-shi (JP)

(21) Appl. No.: 19/339,084

(22) Filed: Sep. 24, 2025

Related U.S. Application Data
(63) Continuation of application No. PCT/JP2024/010811, filed on Mar. 19, 2024.

(30) Foreign Application Priority Data
Mar. 24, 2023 (JP) 2023-047824

(51) Int. Cl. C08J 5/18; B29C 48/00; B29C 48/08; B29C 48/88

(52) U.S. Cl. CPC C08J 5/18; B29C 48/0018; B29C 48/08; B29C 48/88; C08J 2329/12

(57) ABSTRACT

Provided is a method for production a stretched film comprising a poly(3-hydroxybutyrate) resin and exhibiting less shrinkage on heating, comprising melting a film raw material containing the poly(3-hydroxybutyrate) resin with an extruder and molding the film raw material into a film shape; stretching the molded film; and subjecting the stretched film to a heat treatment that includes bringing the film to a temperature T1 and then to a temperature T2, and the temperatures T1 and T2 satisfy the conditions of the formulas (1) to (3):

$$( Melting point of poly ( 3 - hydroxybutyrate ) resin - 70 ) ° C . \leq T 1 \qquad ( 1 )$$

$$T 2 \leq ( melting point of poly ( 3 - hydroxybutyrate ) resin - 20 ) ° C . \qquad ( 2 )$$

$$T 1 \neq T 2 and T 1 < T 2 . \qquad ( 3 )$$

### TECHNICAL FIELD

The present invention relates to a method for producing a stretched film containing a poly(3-hydroxybutyrate) resin.

### BACKGROUND ART

Separate collection and composting of raw garbage have recently been promoted especially in Europe, and there is a demand for plastic products that can be composted together with raw garbage.

Additionally, environmental problems caused by waste plastics have become an issue of great concern. In particular, it has been found that a huge amount of plastics dumped at seas or carried into seas through rivers, etc. are drifting in the ocean on a global scale. Such plastics, which retain their shapes for a long period of time, are pointed out as having various harmful effects on the ecosystems, and examples of plastics-induced problems include: a phenomenon called ghost fishing where plastics catch or trap marine creatures; and eating disorder from which marine creatures having ingested plastics suffer due to the plastics remaining in their digestive organs.

Furthermore, a problem has also been pointed out that plastics are broken into microplastics by the action of ultraviolet rays or any other cause, then the microplastics adsorb hazardous compounds present in seawater, and marine creatures ingest the microplastics with the adsorbed compounds, so that hazardous substances are introduced into the food chain.

While the use of biodegradable plastics is expected for such marine pollution caused by plastics, a report compiled by the United Nations Environment Program in 2015 points out that plastics biodegradable by compost such as polylactic acid cannot be expected to be decomposed in a short period of time in actual oceans with low temperatures, and therefore cannot be taken as measures against marine pollution. Under such circumstances, poly(3-hydroxybutyrate) resins are materials that can undergo biodegradation even in seawater, and thus have attracted attention as materials that solve the above problems.

Meanwhile, as a technique for producing a thin and high-strength film, a method involving stretching a film is known. For example, to produce a stretched film from a general-purpose resin such as polypropylene, a molten resin is cooled and solidified on a cast roll to form a web, and then the web is preheated to a temperature at which the web can be stretched, and then the web is stretched, whereby a stretched film can be continuously produced with high productivity.

However, poly(3-hydroxybutyrate) resins are known as materials that are difficult to stretch due to their characteristics. Patent Literature 1 discloses a method for producing a biaxially stretched film containing a poly(3-hydroxybutyrate) resin with high productivity.

### CITATION LIST

### Patent Literature

PTL 1: JP2022-062759A

### SUMMARY OF INVENTION

### Technical Problem

When a stretched film containing a poly(3-hydroxybutyrate) resin as a main component is used as, for example, a packaging film, the production process may include thermal bonding between stretched films for sealing contents, thermal fixing of ink after placing the ink on the stretched film for printing and the like, but there is a problem that the stretched film shrinks due to such heating and the sealed portion or printing is distorted.

In view of the above current situation, an object of the present invention is to provide a production method by which a stretched film that contains a poly(3-hydroxybutyrate) resin and exhibits less shrinkage on heating can be produced with high productivity.

### Solution to Problem

As a result of intensive studies to solve the above problems, the present inventors have found that a stretched film that contains a poly(3-hydroxybutyrate) resin and exhibits less shrinkage on heating can be produced with high productivity by stretching a film containing a poly(3-hydroxybutyrate) resin and then performing a heat treatment under specific conditions. Based on this finding the inventors have accomplished the present invention.

That is, the present invention relates to a method for producing a stretched film containing a poly(3-hydroxybutyrate) resin, the method including: a step of melting a film raw material containing the poly(3-hydroxybutyrate) resin with an extruder and then molding the film raw material into a film shape; a step of stretching the molded film; and a step of subjecting the stretched film to a heat treatment, in which the heat treatment includes a treatment of bringing the film to a temperature T1 and then to a temperature T2, and the temperatures T1 and T2 satisfy all of the conditions of the following formulas (1) to (3).

$$( Melting point of poly ( 3 - hydroxybutyrate ) resin - 70 ) ° C . \leq T 1 \qquad ( 1 )$$

$$T 2 \leq ( melting point of poly ( 3 - hydroxybutyrate ) resin - 20 ) ° C . \qquad ( 2 )$$

$$T 1 \neq T 2 and T 1 < T 2 \qquad ( 3 )$$

### Advantageous Effects of Invention

According to the present invention, itis possible to provide a production method by which a stretched film that contains a poly(3-hydroxybutyrate) resin and exhibits less shrinkage on heating can be produced with high productivity.

### DESCRIPTION OF EMBODIMENTS

Hereinafter, embodiments of the present invention will be described, but the present invention is not limited to the following embodiments. The present embodiment relates to a method for producing a stretched film containing a poly(3-hydroxybutyrate) resin, the method including: a step of melting a film raw material containing the poly(3-hydroxybutyrate) resin with an extruder and then molding the film raw material into a film shape; a step of stretching the molded film; and a step of subjecting the stretched film to a heat treatment, wherein the heat treatment includes a treatment of bringing the film to a temperature T1 and then to a temperature T2, and the temperatures T1 and T2 satisfy specific conditions.

<Poly(3-hydroxybutyrate) Resin>

The poly(3-hydroxybutyrate) resin is a polyester resin that is an aliphatic polyester resin producible from microorganisms and that has 3-hydroxybutyrate as a repeating unit. The poly(3-hydroxybutyrate) resin may be poly(3-hydroxybutyrate) having only 3-hydroxybutyrate as a repeating unit, or may be a copolymer of 3-hydroxybutyrate and another hydroxyalkanoate. The poly(3-hydroxybutyrate) resin may be a mixture of a homopolymer and one or more copolymers, or a mixture of two or more copolymers.

Examples of the poly(3-hydroxybutyrate) resin include poly(3-hydroxybutyrate), poly(3-hydroxybutyrate-co-3-hydroxyhexanoate) [this may hereinafter be referred to as P3HB3HHL], poly(3-hydroxybutyrate-co-3-hydroxyvalerate) [this may hereinafter be referred to as P3HB3HV], poly(3-hydroxybutyrate-co-4-hydroxybutyrate) [this may hereinafter be referred to as P3HB4HB], poly(3-hydroxybutyrate-co-3-hydroxyoctanoate), and poly(3-hydroxybutyrate-co-3-hydroxyoctadecanoate). Among them, poly(3-hydroxybutyrate), poly(3-hydroxybutyrate-co-3-hydroxyhexanoate), poly(3-hydroxybutyrate-co-3-hydroxyvalerate), and poly(3-hydroxybutyrate-co-4-hydroxybutyrate) are preferable because they are industrially easily produced.

Furthermore, poly(3-hydroxybutyrate-co-3-hydroxyhexanoate) is preferable in that by changing the composition ratio of repeating units, the melting point and the degree of crystallinity can be changed to change physical properties such as Youngs modulus and heat resistance, so that physical properties between polypropylene and polyethylene can be imparted, and the plastic is industrially easily produced and useful in terms of physical properties. In particular, among poly(3-hydroxybutyrate) resins having characteristics of being easily thermally decomposed under heating at 180° C. or more, poly(3-hydroxybutyrate-co-3-hydroxyhexanoate) is preferable from the viewpoint of being able to lower the melting point and enabling molding processing at a low temperature.

Examples of commercially available products of poly(3-hydroxybutyrate-co-3-hydroxyhexanoate) include “KANEKA Biodegradable Polymer PHBH” (registered trademark) of Kaneka Corporation.

When the poly(3-hydroxybutyrate) resin contains a copolymer of a 3-hydroxybutyrate unit and another hydroxyalkanoate unit, the average content ratio of the 3-hydroxybutyrate unit and that of the other hydroxyalkanoate unit accounting for among all monomer units constituting the poly(3-hydroxybutyrate) resin are preferably 3-hydroxybutyrate unit/the other hydroxyalkanoate=99/1 to 80/20 (mol/mol %), more preferably 97/3 to 85/15 (mol %/mol %) from the viewpoint of achieving both strength and productivity of the stretched film.

The average content ratio of each monomer unit accounting for among all monomer units constituting the poly(3-hydroxybutyrate) resin can be determined by a method known to those skilled in the art, for example, the method described in paragraph [0047] of WO2013/147139. The average content ratio means a molar ratio of each monomer unit accounting for among all monomer units constituting the poly(3-hydroxybutyrate) resin, and when the poly(3-hydroxybutyrate) resin is a mixture of two or more poly(3-hydroxybutyrate) resins, the average content ratio means a molar ratio of each monomer unit contained in the entire mixture.

The poly(3-hydroxybutyrate) resin may be a mixture of at least two poly(3-hydroxybutyrate) resins differing in the types and/or contents of constituent monomers.

The weight-average molecular weight of the poly(3-hydroxybutyrate) resin as a whole is not particularly limited. In terms of ensuring both the strength and the productivity of the stretched film, the weight-average molecular weight is preferably from 200,000 to 2,000,000 g/mol, more preferably 250,000 to 1,500,000 g/mol, and still more preferably 300,000 to 1,000,000 g/mol.

The weight-average molecular weight of the poly(3-hydroxybutyrate) resin can be measured as a polystyrene-equivalent molecular weight by gel permeation chromatography (HPLC GPC system manufactured by Shimadzu Corporation) using a chloroform solution. As the column in the gel permeation chromatography, a column suitable for measuring the weight-average molecular weight may be used.

The method for producing the poly(3-hydroxybutyrate) resin is not particularly limited, and may be either a production method by chemical synthesis or a microbial production method. Among them, the microbial production method is preferable. A known method can be applied to the microbial production method. Known examples of bacteria that produce copolymers of 3-hydroxybutyrate with other hydroxyalkanoates include Aeromonas caviae, which is a P3HB3HV- and P3HB3HH-producing bacterium, and Alcaligenes eutrophus, which is a P3HB4HB-producing bacterium. In particular, in order to increase the P3HB3HH productivity, Alcaligenes eutrophus AC32 (FERM BP-6038XT. Fukui, Y Doi, J. Bacteriol., 179, pp. 48214830 (1997)) with a poly-3-hydroxyalkanoate (P3HA) synthase gene introduced is more preferred. Such a microorganism is cultured under suitable conditions to allow the microorganism to accumulate P3HB3HH in its cells, and the microbial cells accumulating P3HB3HH are used. Besides the above microorganisms, genetically-modified microorganisms with various poly(3-hydroxybutyrate) resin synthesis-related genes introduced may also be used in conformity with the intended type of poly(3-hydroxybutyrate) resin to be produced, and culture conditions including the type of a substrate may be optimized.

The poly(3-hydroxybutyrate) resin may be an unmodified resin, or may be a resin prepared by modifying an unmodified poly(3-hydroxybutyrate) resin using a raw material (hereinafter referred to as a “raw material for modification”) that reacts with a resin, such as a peroxide.

When a modified resin is used as a film raw material, a film raw material containing a poly(3-hydroxybutyrate) resin obtained by reacting a raw material for modification in advance may be molded into a film, or at the time of molding a film raw material including an unmodified poly(3-hydroxybutyrate) resin and a raw material for modification, the raw material for modification may be reacted with the resin. When the resin and the raw material for modification are reacted, the whole of the resin may be reacted with the raw material for modification, or a part of the resin may be reacted with the raw material for modification to afford a modified resin, and then the remaining unmodified resin may be added to the modified resin.

The raw material for modification is not particularly limited as long as itis a compound capable of reacting with the poly(3-hydroxybutyrate) resin, but an organic peroxide can be preferably used from the viewpoint of handleability and ease of controlling the reaction with the poly(3-hydroxybutyrate) resin.

Examples of the organic peroxide include diisobutyl peroxide, cumyl peroxyneodecanoate, di-n-propyl peroxydicarbonate, diisopropyl peroxydicarbonate, di-sec-butyl peroxydicarbonate, 1,1,3,3-tetramethylbutyl peroxyneodecanoate, bis(4-t-butylcyclohexyl) peroxydicarbonate, bis(2-ethylhexyl) peroxydicatbonate, t-hexyl peroxyneodecanoate, t-butyl peroxyneodecanoate, t-butyl peroxyneoheptanoate, t-hexyl peroxypivalate, t-butyl peroxypivalate, di(3,5,5-trimethylhexanoyl) peroxide, dilauroyl peroxide, 1,1,3,3-tetramethylbutyl peroxy-2-ethylhexanoate, disuccinic acid peroxide, 2,5-dimethyl-2,5-bis(2-ethylhexanoylperoxy)hexane, t-hexyl peroxy-2-ethylhexanoate, di(4-methylbenzoyl) peroxide, dibenzoyl peroxide, t-butyl peroxy-2-ethylhexylcarbonate, t-butyl peroxyisopropylcarbonate, 1,6-bis(t-butylperoxycarbonyloxy)hexane, t-butyl peroxy-3,5,5-trimethylhexanoate, t-butyl peroxyacetate, t-butyl peroxybenzoate, t-amyl peroxy, 3,5,5-trimethylhexanoate, 2,2-bis(4,4-di-t-butylperoxycyclohexy)propane, and 2,2-di-t-butylperoxybutane. Among these, t-butyl peroxy-2-ethylhexylcarbonate and t-butyl peroxyisopropylcarbonate are preferred. Furthermore, a combination of two or more of these organic peroxides can also be used.

The organic peroxide is used in various forms such as a solid form and a liquid form, and may be a liquid form diluted with a diluent or the like. In particular, an organic peroxide in such a form that the organic peroxide can be easily mixed with the poly(3-hydroxybutyrate) resin (in particular, an organic peroxide being in a liquid form at room temperature (25° C.)) is preferable because it can be more uniformly dispersed in the poly(3-hydroxybutyrate) resin, and a local modification reaction therewith in a resin composition is easily suppressed.

The content of the poly(3-hydroxybutyrate) resin in the stretched film may be 50 wt % or more, 55 wt % or more, 60 wt % or more, 70 wt % or more, or 80 wt % or more. The upper limit of the content of the poly(3-hydroxybutyrate) resin is not limited and may be 100 wt % or less.

The stretched film may contain an additive that can be used together with the poly(3-hydroxybutyrate) resin as long as the effect of the invention is not impaired. Examples of such additives include colorants such as pigments and dyes, odor absorbers such as activated carbon and zeolite, flavors such as vanillin and dextrin, fillers, plasticizers, oxidation inhibitors, antioxidants, weather resistance improvers, ultraviolet absorbers, nucleating agents, lubricants, mold release agents, water repellents, antibacterial agents, and slidability improvers. Only one additive may be contained, or two or more additives may be contained. The content of the additives can be appropriately set by those skilled in the art according to the intended use thereof. Even when a poly(3-hydroxybutyrate) resin contains these additives, the melting point thereof is substantially the same as the melting point of the poly(3-hydroxybutyrate) resin.

Hereinafter, the nucleating agent, the lubricant, the filler, and the plasticizer will be described in more detail.

### (Nucleating Agent)

Examples of the nucleating agent include polyhydric alcohols such as pentaerythritol, galactitol, and mannitol; orotic acid, aspartame, cyanuric acid, glycine, zinc phenylphosphonate, and boron nitride. Among them, pentaerythritol is preferable from the viewpoint that the effect of promoting the crystallization of the poly(3-hydroxybutyrate) resin is particularly excellent. One nucleating agent may be used, or two or more nucleating agents may be used. The proportions of the nucleating agents used can be adjusted as appropriate according to the intended purpose.

The amount of the nucleating agent used is not particularly limited, but is preferably 0.1 to 5 parts by weight, more preferably 0.5 to 3 parts by weight, and still more preferably 0.7 to 1.5 parts by weight, based on 100 parts by weight of the total amount of the poly(3-hydroxybutyrate) resin.

### (Lubricant)

Examples of the lubricant include behenamide, oleamide, erucamide, stearamide, palmitamide, N-stearylbehenamide, N-stearylerucamide, ethylenebisstearamide, ethylenebisoleamide, ethylenebisemucamide, ethylenebislauramide, ethylenebiscapramide, p-phenylenebisstearamide, and a polycondensation product of ethylenediamine, stearic acid, and sebacic acid. Among these, behenamide and erucamide are preferred because they are particularly superior in the lubricating effect on the poly(3-hydroxybutyrate) resin. One lubricant may be used, or two or more lubricants may be used. The proportions of the lubricants used can be adjusted as appropriate according to the intended purpose.

The amount of the lubricant used is not particularly limited, but is preferably 0.01 to 5 parts by weight, more preferably 0.05 to 3 parts by weight, and still more preferably 0.1 to 1.5 parts by weight, based on 100 parts by weight of the total amount of the poly(3-hydroxybutyrate) resin.

### (Filler)

The inclusion of a filler can afford a stretched film with further enhanced strength. The filler may be either an inorganic filler or an organic filler, and both an inorganic filler and an organic filler may be used in combination. The inorganic filler is not particularly limited, and examples thereof include silicates, carbonates, sulfates, phosphates, oxides, hydroxides, nitrides, and carbon black. Only one inorganic filler may be used, or two or more inorganic fillers may be used in combination.

The content of the filler is not particularly limited, but is preferably 1 to 100 parts by weight, more preferably 3 to 80 parts by weight, still more preferably 5 to 70 parts by weight, and further preferably 10 to 60 parts by weight, based on 100 parts by weight of the total amount of the poly(3-hydroxybutyrate) resin. Itis noted that the stretched film may not contain a filler.

### (Plasticizer)

Examples of the plasticizer include glycerin ester compounds, citate ester compounds, sebacate ester compounds, adipate ester compounds, polyether ester compounds, benzoate ester compounds, phthalate ester compounds, isosorbide ester compounds, polycaprolactone compounds, and dibasic ester compounds. Among these, glycerin ester compounds, citate ester compounds, sebacate ester compounds, and dibasic ester compounds are preferred because they are particularly superior in the plasticizing effect on the poly(3-hydroxybutyrate) resin. Examples of the glycerin ester compounds include glycerin diacetomonolaurate. Examples of the citate ester compounds include tributyl acetylcitrate. Examples of the sebacate ester compounds include dibutyl sebacate. Examples of the dibasic ester compounds include benzyl methyl diethylene glycol adipate. One plasticizer may be used, or two or more plasticizers may be used. The proportions of the plasticizers used can be adjusted as appropriate according to the intended purpose.

The amount of the plasticizer used is not particularly limited, but is preferably 1 to 20 parts by weight, more preferably 2 to 15 parts by weight, and still more preferably 3 to 10 parts by weight, based on 100 parts by weight of the total amount of the poly(3-hydroxybutyrate) resin. It is noted that the stretched film may not contain a plasticizer.

### (Other Resins)

The stretched film may contain another resin other than the poly(3-hydroxybutyrate) resin as long as the effect of the invention is not impaired. Examples of such another resin include aliphatic polyester resins such as poly(3-hydroxypropionate), poly(4-hydroxybutyrate), polybutylene succinate adipate, polybutylene succinate, polycaprolactone, and polylactic acid, and aliphatic aromatic polyester resins such as polybutylene adipate terephthalate (hereinafter sometimes referred to as PBAT), polybutylene sebatate terephthalate, and polybutylene azelate terephthalate. Only one other resin may contained, or two or more other resins may be contained.

The content of the other resin is not particularly limited, but may be 100 parts by weight or less, 80 parts by weight or less, 70 parts by weight or less, 50 parts by weight or less, 30 parts by weight or less, 20 parts by weight or less, 10 parts by weight or less, 5 parts by weight or less, or 1 part by weight or less, based on 100 parts by weight of the poly(3-hydroxybutyrate) resin. The lower limit of the content of the other resin is not particularly limited, and may be 0 parts by weight or more.

When the other resin is a resin having a melting point lower than that of the poly(3-hydroxybutyrate) resin, the lower limit of the content of thereof may be 10 parts by weight or more, 20 parts by weight or more, 50 parts by weight or more, or 65 parts by weight or more, based on 100 parts by weight of the poly(3-hydroxybutyrate) resin. The upper limit of the content of the other resin may be less than 100 parts by weight based on 100 parts by weight of the poly(3-hydroxybutyrate) resin.

### <Production of Stretched Film>

A stretched film containing the poly(3-hydroxybutyrate) resin of the present disclosure can be produced by the following production method. A production method including: a step of melting a film raw material containing the poly(3-hydroxybutyrate) resin with an extruder and then molding the film raw material into a film shape; a step of stretching the molded film; and a step of subjecting the stretched film to a heat treatment, wherein the heat treatment includes a treatment of bringing the film to a temperature T1 and then to a temperature T2, and the temperatures T1 and T2 satisfy all of the conditions of the following formulas (1) to (3).

$$( Melting point of poly ( 3 - hydroxybutyrate ) resin - 70 ) ° C . \leq T 1 \qquad ( 1 )$$

$$T 2 \leq ( melting point of poly ( 3 - hydroxybutyrate ) resin - 20 ) ° C . \qquad ( 2 )$$

$$T 1 \neq T 2 and T 1 < T 2 \qquad ( 3 )$$

### (Molding Step)

In the step of melting a film raw material containing a poly(3-hydroxybutyrate) resin with an extruder and then molding the film raw material into a film shape, the method of molding the film raw material into the film shape is not particularly limited, and a known production method may be appropriately used. Specific examples thereof include blown film molding T-die extrusion molding using an extruder equipped with a T-die, calendering and rolling. Among them, blown film molding or T-die extrusion molding is suitable because a strip-shaped film can be produced thereby at high productivity. As the extruder, a single-screw extruder, a twin-screw extruder, or the like can be appropriately used.

The molding temperature is not particularly limited as long as the resin can be appropriately melted, and is preferably, for example, 130 to 200° C. The “molding temperature” referred to herein indicates a resin temperature during the period from resin introduction into the extruder to resin discharge from the die. Generally, the resin temperature can be measured, for example, by a thermometer mounted on an adapter.

### (Blown Film Molding)

The “blown film molding” refers to a molding method in which a molten resin is extruded into the shape of a tube from an extruder fitted at its end with a cylindrical die, and immediately thereafter, a gas is blown into the tube to inflate the tube into the shape of a balloon, and the balloon is molded into a film. The blown film molding is not particularly limited, and can be performed using, for example, a common blown film molding machine for use in molding a thermoplastic resin into a film.

The “common blown film molding machine” refers to a molding machine including a single-screw extruder fitted with a cylindrical die. The single-screw extruder may be any single-screw extruder that melts and kneads an introduced raw material resin and discharges the kneaded resin at a constant rate while maintaining the kneaded resin at a desired temperature. The screw of the single-screw extruder is not particularly limited in shape, etc., but is preferably one including a mixing element in terms of kneading performance. In addition, the structure of the cylindrical die is also not particularly limited, butin particular, a spiral mandrel die is preferable because this is less prone to cause welding and easily attains thickness uniformity.

The haul-off speed in the blown film molding depends on the thickness and width of the film and the resin discharge rate and can be adjusted within a range over which the bubble stability can be ensured. In general, the haul-off speed is preferably 1 to 100 m/min.

In the blown film molding an air ring that blows air onto the exterior of the bubble can be used to solidify the discharged molten resin and stabilize the bubble. A suitable air blowing structure of the air ring is a slit-type structure including: a plurality of annular slits through which air is blown out; and chambers which are located between the slits to facilitate the stabilization of the bubble.

The blow-up ratio (hereinafter sometimes abbreviated as “BUR”) in the blown film molding is a value obtained by dividing the bubble's cross-sectional circumference by the die diameter. The lower limit of the BUR is preferably 1.5 or more, more preferably 1.7 or more, still more preferably 1.9 or more, and particularly preferably 2 or more from the viewpoint of enhancing the film strength. The upper limit of the BUR is preferably 5.5 or less, more preferably 4.5 or less, still more preferably 4.0 or less, and particularly preferably 3.5 or less from the viewpoint of molding stability.

### (T-Die Extrusion Molding)

The “T-die extrusion molding” refers to a molding method in which a molten resin is extruded into the film shape by an extruder from a slit-shaped discharge port onto a cast roll to form a film. The T die is not particularly limited, and a known T die can be appropriately used. For example, the T-die preferably has a discharge port so shaped as to extrude a film-shaped raw material, but is not particularly limited in shape. The shape of the discharge port is also not particularly limited.

In the T-die extrusion molding a film-shaped raw material is extruded from the discharge port of the T-die. The shape of the raw material may be any film-like shape, and the thickness and width thereof are not particularly limited. The thickness is preferably about 20 μm to 600 μm because within this range, there is little thickness unevenness and cooling after extrusion is easy.

The melt viscosity of the raw material extruded from the discharge port of the T-die is not particularly limited, but is preferably 1500 Pa·sec or less because within this range, there is less thickness unevenness and the generation of a die line can be prevented. The melt viscosity can be measured appropriately in accordance with a known method.

The thickness of the film before stretching is not particularly limited, and may be appropriately set in consideration of the thickness, stretch ratio, strength, etc. of the intended stretched film. For example, the thickness is preferably 20 to 600 μm, more preferably 40 to 500 μm, and still more preferably 50 to 300 μm. The thickness of the film can be measured using a caliper.

### (Stretching Step)

In the step of stretching the molded film, the method thereof is not particularly limited as long as stretching is possible, and a known production method can be appropriately used.

The stretching direction in the stretching step is not particularly limited, and the film can be stretched in any direction in the plane of the film. When the stretched film of the present disclosure is a strip-shaped film, the stretching direction may be either the MD direction or the TD direction of the film, or may be both the MD direction and the TD direction. Stretching in one of the MD direction and the TD direction is referred to as uniaxial stretching and stretching in both the MD direction and the TD direction is referred to as biaxial stretching. The MD direction is also called a machine direction, a flow direction, or a length direction. The TD direction is a direction perpendicular to the MD direction, and is also referred to as a vertical direction or a width direction.

The specific technique of stretching is not particularly limited, but a technique of stretching by elongating the film in the stretching direction is preferable. The phrase “elongating a film in the stretch direction” means drawing the film in the stretch direction. On the other hand, by use of a method of stretching a film by applying pressure in the thickness direction of a film, such as rolling in which a film is sandwiched between two rolls, the film is prone to stick to the rolls, so that the productivity of the stretched film may deteriorate.

The technique of stretching the film in the stretching direction is not particularly limited. In the case of batch-type stretching the film can be gripped at both ends and stretched in the stretching direction.

When a film is stretched in the MD direction while being continuously transferred, for example, the stretching in the MD direction can be performed using a roll longitudinal stretching machine while making a difference in the rotation speed of rolls among a plurality of rolls which transfer the film. In this case, the stretch ratio in the MD direction can be determined by the ratio of the rotation speed of the roll after stretching to the rotation speed of the roll before stretching.

When a film is stretched in the TD direction while being continuously transferred, for example, the film can be stretched in the TD direction by operating a transverse stretching machine such as a clip-type tenter with the film clamped at both ends thereof in the width direction and drawing the film in the TD direction. In this case, the stretch ratio in the TD direction can be determined by the ratio of the distance between both end points in the width direction of the film clamped after stretching to the distance between both end points in the width direction of the film clamped before stretching.

The stretch ratio achieved in the step of stretching the molded film is not particularly limited, but is preferably 1.1 or more, more preferably 1.3 or more, still more preferably 1.5 or more, and particularly preferably 2 or more. The upper limit is not particularly limited, and the stretch ratio may be appropriately determined, but may be, for example, 8 or less, 7 or less, 5 or less, or 3 or less.

The stretching temperature is not particularly limited as long as a film can be appropriately stretched, and may be changed according to the mechanical strength, surface properties, thickness accuracy, etc. required for the stretched film to be produced.

The stretching temperature is preferably 40° C. or more, more preferably 50° C. or more, and still more preferably 60° C. or more. The upper limit is merely required to be equal to or lower than the melting point of the poly(3-hydroxybutyrate) resin, and is preferably 150° C. or less, more preferably 145° C. or less, and still more preferably 140° C. or less. When the stretching temperature is within the above temperature range, the thickness unevenness of the resulting stretched film can be reduced, and the mechanical properties such as elongation rate, tear propagation strength, and flexural fatigue resistance can be improved. In addition, it is possible to prevent occurrence of a trouble such as sticking of a film to a roll.

The stretching temperature referred to herein indicates the film temperature during stretching. In general, the stretching temperature can be determined by measuring the temperature of the film body or the ambient temperature in the vicinity of the film using an infrared radiation thermometer, a thermo label, or a thermocouple.

The means for adjusting a film temperature at the time of stretching is not particularly limited, and for example, a non-contact heating technique such as a method of applying hot air heated within the above-described temperature range to a film under stretching a method of heating a film under stretching using an auxiliary heating means such as an infrared heater, and a method of stretching a film in a heating furnace whose temperature is controlled within the above-described temperature range; and a contact heating method such as a method of bringing a film into contact with a roll heated within the above-described temperature range. One of these methods may be used alone, or two or more thereof may be combined.

In the method of bringing a film into contact with a roll heated within the above-described temperature range, hot air may be applied to the film between the upstream stretching roll and the downstream stretching roll in the MD direction.

As a method of applying hot air heated within the above-described temperature range to a film under stretching it is preferable to use a floating-type heating method from the viewpoint of heating efficiency. The floating-type heating is a method of heating a film by blowing hot air from an upper nozzle and a lower nozzle to both surfaces of the film. A plurality of alternating upper and lower nozzles are directed towards the surfaces of the film, and the film can be heated by hot air blown from each of the upper and lower nozzles without contact of the film with any of the upper and lower nozzles.

In the method of heating a film under stretching using an auxiliary heater such as an infrared heater, the film surface and the inside of the film can be heated to the same temperature in a short time, and uniform stretching can be performed over the entire film.

Theinfraredradiationtobeappliedtothefilmmaybeanelectromagneticwaveinageneralinfraredregion and may be any of near-infrared radiation (wavelength=0.74 to 1.5 μm), midinfrared radiation (wavelength=1.5 to 3.0 μm), and far-infrared radiation (wavelength=3.0 μm to 1 mm).

In the method of bringing a film into contact with a roll heated to the above-described temperature range, when the film is stretched using two adjacent stretching rolls while the film is continuously transferred, the intended stretching can be attained by heating the stretching roll positioned upstream in the MD direction of the two adjacent stretching rolls to the above-described temperature range. In this case, the stretching temperature, that is, the film temperature during stretching can be controlled by setting the temperature of the roll to a target stretching temperature.

As a means for adjusting the film temperature during stretching in the production method of the present disclosure, a method of bringing a film into contact with a roll heated within the above temperature range is preferable because of the fact that this method is superior in productivity and from the viewpoint that particularly in the case of mass production, heating can be easily performed. That method is suitable for uniaxial stretching and especially stretching in the MD direction using a plurality of rolls of a roll longitudinal stretching machine.

From the viewpoint of being possible to avoid the problem of sticking of a film to a heating appliance, a non-contact heating method in which the heating appliance heated within the temperature range does not come into contact with the film is preferable.

### (Step of Performing Heat Treatment)

In the step of subjecting the stretched film to a heat treatment, the heat treatment includes a treatment of bringing the film to a temperature T1 and then to a temperature T2, and the temperatures T1 and T2 satisfy all of the conditions of the following formulas (1) to (3).

$$( Melting point of poly ( 3 - hydroxybutyrate ) resin - 70 ) ° C . \leq T 1 \qquad ( 1 )$$

$$T 2 \leq ( melting point of poly ( 3 - hydroxybutyrate ) resin - 20 ) ° C . \qquad ( 2 )$$

$$T 1 \neq T 2 and T 1 < T 2 \qquad ( 3 )$$

If the temperature T2 is higher than (the melting point of the poly(3-hydroxybutyrate) resin −20)° C., the orientation of molecules attained by stretching may be lost, and the mechanical strength of the resulting stretched film may decrease, or sticking of a film to a heating appliance or, in a state where a plurality of films overlap each other, sticking of the films to each other may occur.

If the temperature T1 is lower than (the melting point of the poly(3-hydroxybutyrate) resin −70)° C. and the temperature T2 is higher than (the melting point of the poly(3-hydroxybutyrate) resin −20)° C., the temperature difference between the temperature T1 and the temperature T2 is excessively large, leading to a rapid temperature rise, and sticking of a film to a heating appliance or, in a state where a plurality of films overlap each other, sticking of the films to each other may occur.

In addition, itis preferable that the temperatures T1 and T2 satisfy the conditions of the following formulas (4) and (5).

$$( Melting point of poly ( 3 - hydroxybutyrate ) resin - 70 ) ° C . \leq T 1 \leq ( melting point of poly ( 3 - hydroxybutyrate ) resin - 30 ) ° C . \qquad ( 4 )$$

$$and$$

$$( Melting point of poly ( 3 - hydroxybutyrate ) resin - 60 ) ° C . \leq T 2 \leq ( melting point of poly ( 3 - hydroxybutyrate ) resin - 20 ) ° C . \qquad ( 5 )$$

This makes it possible to further reduce shrinkage on heating in the MD direction and in the TD direction. In particular, shrinkage on heating in the direction in which the film has been stretched in the step of stretching the film can be remarkably reduced.

The melting point of the poly(3-hydroxybutyrate) resin refers to the peak temperature of the melting point peak in a DSC curve obtained by differential scanning calorimetry. The details of differential scanning calorimetry are described in the section of Examples.

In addition, the temperatures T1 and T2 preferably satisfy a relationship of 0° C.<T2−T1≤40° C., and more preferably satisfy a relationship of 10° C.≤T2−T1≤30° C.

The heat treatment may include a treatment of bringing the film to a temperature T2 and then to a temperature T3, and the temperatures T1, T2, and T3 preferably satisfy the conditions of the following formulas (6) and (7).

$$( Melting point of poly ( 3 - hydroxybutyrate ) resin - 40 ) ° C . \leq T 3 \leq ( melting point of poly ( 3 - hydroxybutyrate ) resin - 15 ) ° C . \qquad ( 6 )$$

$$T 1 < T 2 < T 3. \qquad ( 7 )$$

This makes it possible to further reduce shrinkage on heating in the MD direction and in the TD direction. In particular, shrinkage on heating in the direction in which the film has been stretched in the step of stretching the film can be remarkably reduced.

In addition, the temperatures T2 and T3 preferably satisfy a relationship of 0° C.<T3−T2≤40° C., and more preferably satisfy a relationship of 10° C.≤T3−T2≤20° C.

The amount of shrinkage on heating in the stretching direction in the case of heating, at 110° C. for 10 minutes, the stretched film produced by the production method of the present disclosure is preferably 15% or less, more preferably 10% or less, still more preferably 8% or less, and particularly preferably 6% or less. Preferably, the amount of shrinkage on heating is as small as possible, but it may be 0% or more, or 1% or more. The details of the method for measuring the amount of shrinkage on heating are as described in the section of Examples.

In the step of subjecting the stretched film to a heat treatment, the film may be relaxed at each of the times of bringing the film to the temperatures T1, T2, and T3. Among these options, the first option is preferable, that is, it is preferable to relax the film at the time of bringing the film to the temperature T1 because rapid shrinkage on heating of the stretched film and breakage during the production and the processing of the stretched film can be effectively suppressed. The relaxation amount is preferably 0 to 10%, and more preferably 5 to 10%. In particular, by relaxing the film in the stretching direction taken in the step of stretching the film, shrinkage on heating can be further reduced.

The relaxation amount can be calculated by the following formula.

$$Relaxation amount [ \% ] = \{ ( film dimension immediately before bringing the film to temperature Tn ) \text{} - ( film dimension at the time of bringing the film to temperature Tn ) \} / ( film dimension immediately before bringing the film to temperature Tn ) \times 100 ,$$

$$wherein n is 1 , 2 or 3.$$

Herein, relaxation refers to reducing the film dimension in the direction in which the film has been stretched in order to remove the stress in the stretching direction present in the film. The film dimension refers to a distance between two arbitrarily specified points in the film plane, and may be a distance from one end to the other end of the film. When the stretched film of the present disclosure is a strip-shaped film, the film dimension in the MD direction may be a distance between two arbitrarily specified points in the MD direction in the film plane, and the film dimension in the TD direction may be a distance between both end points in the width direction of the film. When slack occurs in the film during the heat treatment, the film dimension is a linear distance between two arbitrarily specified points in the film plane, and may be a linear distance from one end to the other end of the film. In particular, the film dimension in the TD direction may be a linear distance between both end points in the width direction of the film.

When the film is relaxed using two adjacent rolls while the film is continuously transferred, the film dimension in the MD direction can be adjusted by making a difference between the rotation speeds of the two adjacent rolls. The film dimension in the TD direction can be adjusted by clamping both ends of the film in the width direction using a transverse stretching machine such as a clip-type tenter and changing the distance between the clamp portions.

Specifically, the relaxation amount [%] in the MD direction in the step of performing the heat treatment can be calculated by the following formula (i-i), and the relaxation amount [%] in the TD direction can be calculated by the following formula (i-ii).

$$Relaxation amount in MD direction [ \% ] = \{ ( rotation speed of the roll located immediately before the roll for bringing the film to temperature Tn ) \text{} - ( rotation speed of the roll for bringing the film to temperature Tn ) \} / ( rotation speed of the roll located immediately before the roll for bringing the film to temperature Tn ) \times 100 , \qquad ( i - i )$$

$$wherein n is 1 , 2 or 3.$$

$$Relaxation amount in TD direction [ \% ] = \{ ( distance between both end points in width direction of film immediately before bringing the film to temperature Tn ) \text{} - ( distance between both end points in width direction of film at the time of bringing the film to temperature Tn ) \} / ( distance between both end points in width direction of the film immediately before bringing the film to temperature Tn ) \times 100 , \qquad ( i - ii )$$

$$wherein n is 1 , 2 or 3.$$

The times to be taken for bringing the film to the temperatures T1, T2, and T3 are not particularly limited, respectively, but are preferably 0.5 to 30 seconds, more preferably 0.5 to 10 seconds, and still more preferably 0.5 to 5 seconds from the viewpoint of productivity.

The means for adjusting the film temperature in the heat treatment is not particularly limited, and for example, a non-contact heating technique such as a method of applying hot air heated within the above-described temperature range to a film, a method of heating a film using an auxiliary heating means such as an infrared heater, and a method involving placing a film in a heating furnace whose temperature is controlled within the above-described temperature range and heating the film; and a contact heating method such as a method of bringing a film into contact with a roll heated within the above-described temperature range. One of these methods may be used alone, or two or more thereof may be combined.

As the means for adjusting the film temperature in the heat treatment, the same means as the means for adjusting the film temperature during stretching can be used, and thus the description of each method is omitted.

According to the production method of the present disclosure, since sticking to a heating appliance, especially, a roll does not occur, as a means for adjusting the film temperature in the heat treatment, a method of bringing a film into contact with a roll heated within the above temperature range is preferable because of the fact that this method is superior in productivity and from the viewpoint that particularly in the case of mass production, heating can be easily performed. That method is suitable for uniaxial stretching and especially stretching in the MD direction of the film using a plurality of rolls of a roll longitudinal stretching machine in that the film can be transferred continuously and high productivity can be attained.

When blown film molding is used in the step of melting a film raw material containing a poly(3-hydroxybutyrate) resin with an extruder and then molding it into a film shape, the molten resin is extruded into a tube shape from the extruder, so that the film after molding is brought into a state where films are in contact with each other. Therefore, films may stick to each other depending on the conditions of the heat treatment, but according to the production method of the present disclosure, sticking of films can be avoided, and thus the method is superior in productivity.

The treatment of bringing the film sequentially to the temperature T1, the temperature T2, and the temperature T3 may be a treatment of bringing the film into contact with rolls. Specifically, the intended purpose can be attained by bringing the film sequentially into contact with a roll R1 kept at a temperature T1, a roll R2 kept at a temperature T2, and a roll R3 kept at a temperature T3.

When a method of bringing the film into contact with rolls heated within the above-described temperature ranges is used as means for adjusting the film temperature, the times for bringing the film to the temperature T1, the temperature T2, and the temperature T3 refer to the time for holding the film in contact with the roll R1 kept at the temperature T1, the roll R2 kept at the temperature T2, and the roll R3 kept at the temperature T3, respectively. The roll R1 kept at the temperature T1 may be constituted not only of a single roll but also of two or more rolls. Similarly, each of the roll R2 kept at the temperature T2 and the roll R3 kept at the temperature T3 may be constituted of either a single roll or two or more rolls. The times for bringing the film to the temperature T1, the temperature T2, and the temperature T3 can be adjusted by increasing or decreasing the rotation speeds of the rolls R1, R2, and R3 or the number of rolls.

The rotation speeds of the roll R1 for bringing the film to the temperature T1, the roll R2 for bringing the film to the temperature T2, and the roll R3 for bringing the film to the temperature T3 are not particularly limited, respectively. From the viewpoint that the shrinkage on heating after stretching can be further reduced by adjusting the above-described relaxation amount to 0 to 10% or 5 to 10%, the ratio of the rotation speed of the roll R1 to the rotation speed of the roll located immediately before the roll R1, the ratio of the rotation speed of the roll R2 to the rotation speed of the roll R1, and the ratio of the rotation speed of the roll R3 to the rotation speed of the roll R2 are each preferably 90 to 100%, and more preferably 90 to 95%. In particular, it is particularly preferable to adjust the ratio of the rotation speed of the roll R1 to the rotation speed of the roll located immediately before the roll R1 within the above range because rapid shrinkage on heating of a stretched film and breakage of the stretched film during production and processing can be effectively suppressed.

The production method of the present disclosure may include a step of cooling the film after the step of heat-treating the film. The film temperature in the step of cooling the film may be 60° C. or less, and is preferably 40° C. or less. The means for cooling the film is not particularly limited as long as the film temperature can be made lower than the temperature of the heat treatment, and examples thereof include a method of bringing the film into contact with a roll adjusted to 60° C. or less, and preferably 40° C. or less. More specifically, the film may be cooled on one or more rolls, or may be cooled by sandwiching the film between two rolls.

From the viewpoint of productivity, the production method of the present disclosure is preferably conducted in a continuous process from the step of melting a film raw material with an extruder and then molding the melted film raw material into a film shape to the step of performing a heat treatment, especially, to the acquisition of a stretched film. Herein, the continuous process refers to acquiring a stretched film by sequentially performing a step of melting a film raw material with an extruder and then molding the melted film raw material into a film shape, a step of stretching the molded film, a step of heat-treating the stretched film, and, as necessary, a step of cooling the film.

### <Thickness of Stretched Film>

The thickness of the stretched film is not particularly limited, and may be appropriately set to a desired thickness. From the viewpoint of uniform thickness, appearance, strength, lightness, etc. of the film, the thickness is preferably 10 to 200 μm, more preferably 15 to 150 μm, and still more preferably 20 to 100 μm. The thickness of the film can be measured using a caliper.

Since the stretched film of the present disclosure has high strength even if it is thin, it can be suitably used as a packaging film, for example, a packaging film for foods and the like for which heat sealability is required.

In the following items, preferred aspects of the present disclosure are listed, but the present invention is not limited to the following items.

[Item 1] A method for producing a stretched film containing a poly(3-hydroxybutyrate) resin, the method including:
a step of melting a film raw material containing the poly(3-hydroxybutyrate) resin with an extruder and then molding the film raw material into a film shape;
a step of stretching the molded film; and
a step of subjecting the stretched film to a heat treatment,
in which the heat treatment includes a treatment of bringing the film to a temperature T1 and then to a temperature T2, and the temperatures T1 and T2 satisfy all of the conditions of the following formulas (1) to (3).

$$( Melting point of poly ( 3 - hydroxybutyrate ) resin - 70 ) ° C . \leq T 1 \qquad ( 1 )$$

$$T 2 \leq ( melting point of poly ( 3 - hydroxybutyrate ) resin - 20 ) ° C . \qquad ( 2 )$$

$$T 1 \neq T 2 and T 1 < T 2 \qquad ( 3 )$$

[Item 2] The production method according to item 1, in which the temperatures T1 and T2 satisfy the conditions of the following formulas (4) and (5).

$$( Melting point of poly ( 3 - hydroxybutyrate ) resin - 70 ) ° C . \leq T 1 \leq ( melting point of poly ( 3 - hydroxybutyrate ) resin - 30 ) ° C . \qquad ( 4 )$$

$$and$$

$$( Melting point of poly ( 3 - hydroxybutyrate ) resin - 60 ) ° C . \leq T 2 \leq ( melting point of poly ( 3 - hydroxybutyrate ) resin - 20 ) ° C . \qquad ( 5 )$$

[Item 3] The production method according to item 1 or 2, in which the heat treatment includes a treatment of bringing the film to a temperature T2 and then to a temperature T3, and the temperatures T1, T2, and T3 satisfy the conditions of the following formulas (6) and (7).

$$( Melting point of poly ( 3 - hydroxybutyrate ) resin - 40 ) ° C . \leq T 3 \leq ( melting point of poly ( 3 - hydroxybutyrate ) resin - 15 ) ° C . \qquad ( 6 )$$

$$T 1 < T 2 < T 3. \qquad ( 7 )$$

[Item 4] The production method according to any one of items 1 to 3, in which the treatment of bringing the film to the temperature T1 is
a treatment of bringing the film into contact with a roll R1 kept at the temperature T1, and the treatment of bringing the film to the temperature T2 is a treatment of bringing the film into contact with a roll R2 kept at the temperature T2.

[Item 5] The production method according to any one of items 1 to 4, in which the film is brought to the temperature T1 at a relaxation amount of 0 to 10% in the stretching direction.

[Item 6] The production method according to any one of items 1 to 5, in which the time to be taken for bringing the film to the temperature T1 is 0.5 to 30 seconds.

[Item 7] The production method according to any one of items 1 to 6, in which the time to be taken for bringing the film to the temperature T2 is 0.5 to 30 seconds.

[Item 8] The production method according to any one of items 1 to 7, in which the poly(3-hydroxybutyrate) resin is poly(3-hydroxybutyrate-co-3-hydroxyhexanoate).

[Item 9] The production method according to any one of items 1 to 8, in which the stretching is uniaxial stretching.

### EXAMPLES

Hereinafter, the present invention will be described more specifically using Examples and Comparative Examples, but the present invention is not limited by Examples at all.

In Examples and Comparative Examples, the following raw materials were used.

### Production of Poly(3-Hydroxybutyrate) Resin A-1 and Resin Pellet P-1

A poly(3-hydroxybutyrate) resin A-1: P3HB3HH (average content ratio: 3-hydroxybutyrate unit/3-hydroxyhexanoate unit [3HB/3HH]=94/6 (mol/mol %), weight-average molecular-weight:600,000 g/mol, glass transition temperature: 6° C.) was produced in accordance with the method described in Example 1 of WO 2019/142845. The melting point of the resin A-1 was 146° C.

0.5 parts by weight of behenamide (BNT-22H manufactured by Nippon Fine Chemical Co., Ltd.) as a lubricant was dry-blended with 100 parts by weight of the poly(3-hydroxybutyrate) resin A-1. The dry blend was charged into a 26-mm-diameter corotating tin-screw extruder whose cylinder temperature and die temperature were set to 150° C., and then extruded. The resulting strand was passed through a water bath filled with 45° C. warm water to solidify, and cut with a pelletizer, whereby resin pellets P-1 were obtained.

### (Weight-Average Molecular Weight)

The weight-average molecular weight of resin was measured in terms of polystyrene using the above-described gel permeation chromatography (HPLC GPC system manufactured by Shimadzu Corporation).

### (Glass Transition Temperature)

The glass transition temperature (Tg) of resin was determined by differential scanning calorimetry in accordance with JIS K-7121.

Specifically, about 5 mg of a sample to be measured was precisely weighed first, and the temperature was raised from −20° C. to 200° C. at a temperature increase rate of 10° C./min with a differential scanning calorimeter (SSC5200 manufactured by Seiko Instruments & Electronics Ltd.), and thus a DSC curve was obtained. Next, in the resulting DSC curve and specifically in a portion exhibiting a stepwise baseline shift arising from glass transition, straight extensions of the pre-shift baseline and the post-shift baseline were drawn, and a centerline equidistant from the two straight extensions in the direction of the ordinate axis was drawn. The temperature at the point where the center line intersected the glass transition-induced stepwise shift portion of the DSC curve was determined as the glass transition temperature (Tg).

### (Melting Point)

The melting point was determined by differential scanning calorimetry in accordance with JISK-7121.

Specifically, about 4 to 5 mg of a sample to be measured was precisely weighed first, and the temperature was raised from 0° C. to 180° C. at a temperature increase rate of 10° C./min with a differential scanning calorimeter (SSC5200 manufactured by Seiko Instruments & Electronics Ltd.), and thus a DSC curve was obtained. In the resulting DSC curve, the temperature at which the top of the melting point peak was located was determined as the melting point.

### (Thickness of Film)

The thickness of a film was measured using a caliper at 10 points spaced at intervals of 10 cm in the TD direction. An arithmetic mean of the 10 thickness values was calculated as the thickness of the film.

### (Sticking to Roll)

The film produced in each of Examples and Comparative Examples was brought into contact with a roll (having a surface made of stainless steel) heated to the highest temperature among the heat treatment conditions in each of Examples and Comparative Examples, and the presence or absence of sticking to the roll was checked.

### (Sticking Between Films)

Two films produced in each of Examples and Comparative Examples was superposed and brought into contact with a roll (having a surface made of stainless steel) heated to the highest temperature among the heat treatment conditions in each of Examples and Comparative Examples, and the presence or absence of sticking between the films was checked.

### (Amount of Film Shrinkage on Heating)

A film to be measured was cut into a square of 5 cm in MD direction×5 cm in TD direction, and heated in an oven set at 110° C. for 10 minutes. Further, the dimensions of the film after heating in the MD direction and the TD direction were measured, and the amounts of shrinkage on heating in the MD direction and the TD direction were determined from the following formulas on the basis of the dimensions in the MD direction and the TD direction, respectively.

$$Amount of shrinkage on heating [ \% ] = ( 1 - ( dimension after heating ) / ( dimension before heating ) ) \times 100$$

### Example 1

Using a blown film molding machine including a 50-mm-diameter single-screw extruder and a blown film molding die (die diameter: 100 mm, lip clearance: 1.0 mm), a resin prepared by dry-blending the resin pellets P-1 and PBAT (ecoflex (registered trademark) F Blend C1200 manufactured by BASF) at a weight ratio of P-1: PBAT=10:7 was charged as a film raw material into the extruder, and molded into a film shape at a discharge rate of 29 kg/h, a resin temperature of 165° C., a lay-flat film width of 390 mm (blow up ratio: 2.5), and a haul-off speed of 5 m/min. After being molded into a film shape, the film was used as a film web. The film web was hauled with a haul-off roll, and continuously stretched by a roll longitudinal stretching machine at a stretching temperature of 64 to 65° C. such that a stretch ratio in the longitudinal (MD) direction of 3 would be attained.

A test piece sized 100 mm×210 mm was cut out from the stretched film (cut out such that the short side extended along the MD direction), the test piece was placed in a hot air oven with all four sides held (relaxation amount in the MD direction: 0%), and the test piece was kept at a film temperature of 90° C. for 10 seconds, and then taken out, whereby a heat-treated stretched film of the first stage was acquired. Thereafter, the film was placed in a hot air oven with all four sides held (relaxation amount in the MD direction: 0%), kept at a film temperature of 120° C. for 10 seconds, and then taken out, whereby a heat-treated stretched film of the second stage was acquired. Furthermore, the film was placed in a hot air oven with all four sides held (relaxation amount in the MD direction: 0%), kept at a film temperature of 130° C. for 10 seconds, and then taken out, whereby a heat-treated stretched film of the third stage was acquired. The resulting stretched film did not stick to a roll or stretched films did not stick to each other. Furthermore, the amount of shrinkage on heating was 4% in the MD direction and 0% in the TD direction. The evaluation results of the stretched film are shown in Table 1.

TABLE 1

| | | | Heat treatment conditions | | | | | | Evaluation of stretched film | | | |
|---|---|---|---|---|---|---|---|---|---|---|---|---|
| | Film raw material | | First stage | | Second stage | | Third stage | | | | | Amount of |
| | | Melting | | Relaxation | | Relaxation | | Relaxation | | | | shrinkage |
| | | point | | amount in | | amount in | | amount in | Thick- | | | on heating |
| | Resin | of A-1 | T1 | MD direction | T2 | MD direction | T3 | MD direction | ness | Sticking | Sticking | MD(%)/ |
| | component | (C) | (° C.) | (%) | (° C.) | (%) | (° C.) | (%) | (μm) | to roll | of films | TD(%) |
| Example 1 | A-1/PBAT | 146 | 90 | 0 | 120 | 0 | 130 | 0 | 23 | No | No | 4%/0% |
| Example 2 | A-1/PBAT | 146 | 90 | 10 | 110 | 0 | 120 | 0 | 23 | No | No | 4%/0% |
| Example 3 | A-1/PBAT | 146 | 80 | 5 | 90 | 0 | 110 | 10 | 23 | No | No | 3%/1% |
| Example 4 | A-1/PBAT | 146 | 90 | 0 | 120 | 0 | — | — | 23 | No | No | 6%/0% |
| Comparative | A-1/PBAT | 146 | — | — | — | — | — | — | 23 | Yes | Yes | 20%/3% |
| Example 1 | | | | | | | | | | | | |
| Comparative | A-1/PBAT | 146 | 130 | 0 | — | — | — | — | 23 | Yes | Yes | 4%/0% |
| Example 2 | | | | | | | | | | | | |
| Comparative | A-1/PBAT | 146 | 90 | 0 | 130 | 0 | — | — | 23 | Yes | Yes | 4%/0% |
| Example 3 | | | | | | | | | | | | |
| Comparative | A-1/PBAT | 146 | 90 | 0 | 90 | 0 | 90 | 0 | 23 | No | No | 16%/2% |
| Example 4 | | | | | | | | | | | | |

### Example 2

A stretched film was acquired in the same manner as in Example 1 except that the film temperature and the relaxation amount in the MD direction were changed to 90° C. and 100%, respectively, as the first stage heat treatment conditions, the film temperature was changed to 110° C. as the second stage heat treatment condition, and the film temperature was changed to 120° C. as the third stage heat treatment condition in Example 1. The resulting stretched film did not stick to a roll or stretched films did not stick to each other. Furthermore, the amount of shrinkage on heating was 4% in the MD direction and 0% in the TD direction. The evaluation results of the stretched film are shown in Table 1.

### Example 3

A stretched film was acquired in the same manner as in Example 1 except that the film temperature and the relaxation amount in the MD direction were changed to 80° C. and 5%, respectively, as the first stage heat treatment conditions, the film temperature was changed to 90° C. as the second stage heat treatment condition, and the film temperature and the relaxation amount in the MD direction were changed to 110° C. and 10%, respectively, as the third stage heat treatment conditions in Example 1. The resulting stretched film did not stick to a roll or stretched films did not stick to each other. Furthermore, the amount of shrinkage on heating was 3% in the MD direction and 1% in the TD direction. The evaluation results of the stretched film are shown in Table 1.

### Example 4

A stretched film was acquired in the same manner as in Example 1 except that the third-stage heat treatment was not performed in Example 1. The resulting stretched film did not stick to a roll or stretched films did not stick to each other. Furthermore, the amount of shrinkage on heating was 6% in the MD direction and 0% in the TD direction. The evaluation results of the stretched film are shown in Table 1.

### Comparative Example 1

A stretched film was acquired in the same manner as in Example 1 except that the heat treatment was not performed in Example 1. However, sticking to a roll and sticking of films to each other occurred. In addition, the amount of shrinkage on heating was 20% in the MD direction and 3% in the TD direction. The evaluation results of the stretched film are shown in Table 1.

### Comparative Example 2

A film was acquired in the same manner as in Example 1 except that in Example 1, the film temperature was changed to 130° C. as the first stage heat treatment condition, and the second stage and third stage heat treatments were not performed. However, sticking to a roll and sticking of films to each other occurred. The evaluation results of the stretched film are shown in Table 1.

### Comparative Example 3

An attempt was made to produce a film in the same manner as in Example 1 except that the film temperature was changed to 90° C. as the first stage heat treatment condition, the film temperature was changed to 130° C. as the second stage heat treatment condition, and the third stage heat treatment was not performed in Example 1. However, sticking to a roll and sticking of films to each other occurred. The evaluation results of the stretched film are shown in Table 1.

### Comparative Example 4

An attempt was made to produce a film in the same manner as in Example 1 except that the film temperature was changed to 90° C. as the heat treatment conditions of the first stage through the third stage in Example 1. As a result, although there was no sticking of the film to the roll or sticking between films, the amount of shrinkage on heating was 160 in the MD direction and 2% in the TD direction. The evaluation results of the stretched film are shown in Table 1.

In Examples 1 to 4, in which as heat treatment conditions, a treatment of bringing a film to a temperature T1 and then to a temperature T2 is included and the temperatures T1 and T2 satisfy all of the conditions of the above formulas (1) to (3), the amount of shrinkage on heating in the TD direction is 1% or less, the amount of shrinkage on heating in the MD direction, which is the stretching direction, is also as small as less than 10%, and there is no sticking to the roll or sticking between films, so that it can be seen that the films can be produced with high productivity.

1: A method for producing a stretched film comprising a poly(3-hydroxybutyrate) resin, the method comprising:
melting a film raw material comprising the poly(3-hydroxybutyrate) resin with an extruder and then molding the film raw material into a film shape;
stretching the molded film; and
subjecting the stretched film to a heat treatment,
wherein the heat treatment comprises bringing the film to a temperature T1, then to a temperature T2, and then to a temperature T3, wherein the temperatures T1, T2, and T3 satisfy the conditions of the following formulas (1) to (3):
$$( Melting point of poly ( 3 - hydroxybutyrate ) resin - 70 ) ° C . \leq T 1 \qquad ( 1 )$$
$$T 2 \leq ( melting point of poly ( 3 - hydroxybutyrate ) resin - 20 ) ° C . , \qquad ( 2 )$$
$$and$$
$$T 1 \neq T 2 and T 1 < T 2 , \qquad ( 3 )$$
the conditions of the following formulas (6) and (7):
$$( Melting point of poly ( 3 - hydroxybutyrate ) resin - 40 ) ° C . \leq T 3 \leq ( melting point of poly ( 3 - hydroxybutyrate ) resin - 15 ) ° C . \qquad ( 6 )$$
$$T 1 < T 2 < T 3. \qquad ( 7 )$$

2: The method according to claim 1, wherein the temperatures T1 and T2 satisfy the conditions of the following formulas (4) and (5):
$$( Melting point of poly ( 3 - hydroxybutyrate ) resin - 70 ) ° C . \leq T 1 \leq ( melting point of poly ( 3 - hydroxybutyrate ) resin - 30 ) ° C . , \qquad ( 4 )$$
$$and$$
$$( Melting point of poly ( 3 - hydroxybutyrate ) resin - 60 ) ° C . \leq T 2 \leq ( melting point of poly ( 3 - hydroxybutyrate ) resin - 20 ) ° C . \qquad ( 5 )$$

3. (canceled)

4: The method according to claim 1, wherein the bringing the film to the temperature T1 comprises bringing the film into contact with a roll R1 kept at the temperature T1, and the bringing the film to the temperature T2 comprises bringing the film into contact with a roll R2 kept at the temperature T2.

5: The method according to claim 1, wherein the film is brought to the temperature T1 at a relaxation amount of from 0 to 10% in a stretching direction.

6: The method according to claim 1, wherein a time to bring the film to the temperature T1 is from 0.5 to 30 seconds.

7: The method according to claim 1, wherein a time to bring the film to the temperature T2 is from 0.5 to 30 seconds.

8: The method according to claim 1, wherein the poly(3-hydroxybutyrate) resin is poly(3-hydroxybutyrate-co-3-hydroxyhexanoate).

9: The method according to claim 1, wherein the stretching is uniaxial stretching.
